(19) United States
(12) Patent Application Publication
(10) Pub. No.: US 2021/0210963 A1
(43) Pub. Date: Jul. 8, 2021

(54) UNIVERSAL SERIAL BUS POWER-SUPPLYING APPARATUS WITH DELAY FUNCTIONS

(71) Applicant: Powergene Technology Co., Ltd., Taiwan Branch, New Taipei City (TW)

(72) Inventors: Hui-Te HSU, New Taipei City (TW); Huei-Ju TSAI, New Taipei City (TW)

(21) Appl. No.: 16/733,979

(22) Filed: Jan. 3, 2020

(51) Int. Cl. H02J 7/00

(52) U.S. Cl. CPC H02J 7/00034; H02J 2207/30; H02J 7/007182

(57) ABSTRACT

A universal serial bus power-supplying apparatus with delay functions includes a power convertor, a power delivery communication controller and a plurality of switch units. The power delivery communication controller calculates a first communication time between the universal serial bus power-supplying apparatus and a first electronic apparatus. The power delivery communication controller calculates a second communication time between the universal serial bus power-supplying apparatus and a second electronic apparatus. The universal serial bus power-supplying apparatus utilizes a time difference between the first communication time and the second communication time to simultaneously supply power to the first electronic apparatus and the second electronic apparatus to drive the first electronic apparatus and the second electronic apparatus.

### BACKGROUND OF THE INVENTION

### Field of the Invention

The present invention relates to a universal serial bus power-supplying apparatus, and especially relates to a universal serial bus power-supplying apparatus with delay functions.

### Description of the Related Art

The type-C USB PD (power delivery) has to support multiple outputs to supply power to multiple electronic apparatuses. When more than two electronic apparatuses are connected to the type-C USB PD, the fast charging voltage requested by every electronic apparatus may be different (may be 9, 12, 15 or 20 volts), and the communication time between the type-C USB PD and every electronic apparatus may be also different, wherein the communication contents are: what kinds of voltages the type-C USB PD can supply, and the requirement voltage of the electronic apparatus and so on. Therefore, a related art type-C USB PD will comprise a lot of power convertors to respectively correspond to different power output ports and different electronic apparatuses. However, because the related art type-C USB PD comprises a lot of power convertors, the cost of the related art type-C USB PD is very high.

Another related art type-C USB PD comprises only one power convertor. Because the communication time between the type-C USB PD and every electronic apparatus may be different, this kind of related art type-C USB PD which comprises only one power convertor uniformly outputs only 5 volts when being connected to more than two electronic apparatuses, to avoid damaging the electronic apparatus which may exist and requests only 5 volts. For example, one electronic apparatus requests 9 volts while another electronic apparatus requests only 5 volts; if the type-C USB PD outputs 9 volts, the electronic apparatus which requests only 5 volts will be damaged. In other words, for this kind of related art type-C USB PD which comprises only one power convertor, even if more than two electronic apparatuses which are connected to the related art type-C USB PD request the same voltage which is not 5 volts (for example, request 9 volts), this kind of related art type-C USB PD uniformly outputs only 5 volts, which is a pity.

### SUMMARY OF THE INVENTION

In order to solve the above-mentioned problems, an object of the present invention is to provide a universal serial bus power-supplying apparatus with delay functions.

In order to achieve the object of the present invention mentioned above, the universal serial bus power-supplying apparatus of the present invention is applied to a first electronic apparatus and a second electronic apparatus. The universal serial bus power-supplying apparatus comprises a power convertor, a power delivery communication controller and a plurality of switch units. The power delivery communication controller is electrically connected to the power convertor. The switch units are electrically connected to the power convertor and the power delivery communication controller. Moreover, the power delivery communication controller is configured to calculate a first communication time between the universal serial bus power-supplying apparatus and the first electronic apparatus. The power delivery communication controller is configured to calculate a second communication time between the universal serial bus power-supplying apparatus and the second electronic apparatus. The universal serial bus power-supplying apparatus is configured to utilize a time difference between the first communication time and the second communication time to simultaneously supply power to the first electronic apparatus and the second electronic apparatus to drive the first electronic apparatus and the second electronic apparatus.

The advantage of the present invention is that the universal serial bus power-supplying apparatus can simultaneously supply the voltage more than 5 volts to more than two electronic apparatuses but only one power convertor is requested and utilized.

### BRIEF DESCRIPTION OF DRAWING

FIG. 1 shows a block diagram of the universal serial bus power-supplying apparatus of the present invention.

FIG. 2 shows a timing diagram of the delay power-on project of the present invention.

FIG. 3 shows a timing diagram of the delay communication project of the present invention.

FIG. 4 shows a flow chart of the method applied to the universal serial bus power-supplying apparatus of the present invention (for the delay power-on project).

FIG. 5 shows a flow chart of the method applied to the universal serial bus power-supplying apparatus of the present invention (for the delay communication project).

### DETAILED DESCRIPTION OF THE INVENTION

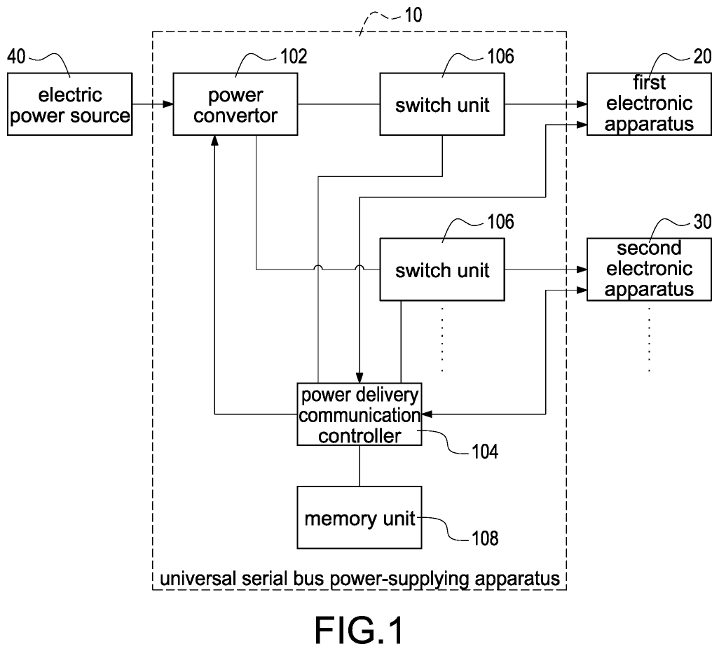

FIG. 1 shows a block diagram of the universal serial bus power-supplying apparatus of the present invention. A universal serial bus power-supplying apparatus 10 (for example, a type-C USB PD) with delay functions is applied to a first electronic apparatus 20, a second electronic apparatus 30 and an electric power source 40 (for examples, an alternating current power, a direct current power or a battery, to supply power to the power convertor 102 mentioned below). The universal serial bus power-supplying apparatus 10 comprises a power convertor 102, a power delivery communication controller 104, a plurality of switch units 106 and a memory unit 108. The components mentioned above are electrically connected to each other. It is noted that FIG. 1 comprises only two electronic apparatuses but the practical application is not limited by it; more than three electronic apparatuses can be comprised. The power delivery communication controller 104 can control the power convertor 102 to convert and output 5, 9, 12, 15 or 20 volts direct current voltage, and can control the switch units 106 to be turned on or off to determine whether the voltage generated by the power convertor 102 can be outputted to the corresponding electronic apparatus or not.

The main concepts of the present invention are that the power delivery communication controller 104 is configured to calculate a first communication time between the universal serial bus power-supplying apparatus 10 and the first electronic apparatus 20; the power delivery communication controller 104 is configured to calculate a second communication time between the universal serial bus power-supplying apparatus 10 and the second electronic apparatus 30; the universal serial bus power-supplying apparatus 10 is configured to utilize a time difference between the first communication time and the second communication time to simultaneously supply power to the first electronic apparatus 20 and the second electronic apparatus 30 to drive the first electronic apparatus 20 and the second electronic apparatus 30. Moreover, the memory unit 108 is configured to store the first communication time, the second communication time and the time difference; the time difference is greater than 0 second.

The first communication time is defined as: from the universal serial bus power-supplying apparatus 10 sends out a first initial communication signal, until the universal serial bus power-supplying apparatus 10 receives a first requirement signal. Moreover, the first initial communication signal sent by the universal serial bus power-supplying apparatus 10 is sent to the first electronic apparatus 20; the first requirement signal received by the universal serial bus power-supplying apparatus 10 is sent by the first electronic apparatus 20; the first requirement signal is used to indicate a magnitude of a requirement voltage of the first electronic apparatus 20.

The second communication time is defined as: from the universal serial bus power-supplying apparatus 10 sends out a second initial communication signal, until the universal serial bus power-supplying apparatus 10 receives a second requirement signal. Moreover, the second initial communication signal sent by the universal serial bus power-supplying apparatus 10 is sent to the second electronic apparatus 30; the second requirement signal received by the universal serial bus power-supplying apparatus 10 is sent by the second electronic apparatus 30; the second requirement signal is used to indicate a magnitude of a requirement voltage of the second electronic apparatus 30.

Generally speaking, an initial condition of the present invention is that: Firstly, the first electronic apparatus 20 has been connected to the universal serial bus power-supplying apparatus 10, and the universal serial bus power-supplying apparatus 10 has supplied power to the first electronic apparatus 20 to drive the first electronic apparatus 20; this means that the universal serial bus power-supplying apparatus 10 has completed a communication with the first electronic apparatus 20 and has been aware of the first requirement signal and the first communication time. Then, if the second electronic apparatus 30 intends to connect to the universal serial bus power-supplying apparatus 10 and after the second electronic apparatus 30 is connected to the universal serial bus power-supplying apparatus 10, the universal serial bus power-supplying apparatus 10 stops supplying power to the first electronic apparatus 20, and the universal serial bus power-supplying apparatus 10 communicates with the second electronic apparatus 30, so that the power delivery communication controller 104 is configured to calculate the second communication time between the universal serial bus power-supplying apparatus 10 and the second electronic apparatus 30 and is configured to be aware of the second requirement signal and the second communication time. Later, the universal serial bus power-supplying apparatus 10 also stops communicating with the second electronic apparatus 30. Later, the present invention will firstly determine whether the magnitude of the requirement voltage of the first electronic apparatus 20 indicated by the first requirement signal is equal to the magnitude of the requirement voltage of the second electronic apparatus 30 indicated by the second requirement signal or not. If they are different, because the present invention has only one power convertor 102, after the universal serial bus power-supplying apparatus 10 re-powers on the first electronic apparatus 20 and the second electronic apparatus 30 and completes the communications again (because as mentioned above, the universal serial bus power-supplying apparatus 10 has stopped supplying power to the first electronic apparatus 20, and the universal serial bus power-supplying apparatus 10 also has stopped communicating with the second electronic apparatus 30, the universal serial bus power-supplying apparatus 10 will communicate with the first electronic apparatus 20 and the second electronic apparatus 30 again after re-powering on), the power convertor 102 will output only 5 volts voltage. But if they are the same, the present invention provides two delay projects: a delay power-on project and a delay communication project, which are described in details as following:

(A) The delay power-on project comprises following two conditions:

1. If the second communication time is greater than the first communication time: the second communication time minus the first communication time obtains the time difference by the power delivery communication controller 104. Firstly, the universal serial bus power-supplying apparatus 10 re-powers on the first electronic apparatus 20 and the second electronic apparatus 30, so that the universal serial bus power-supplying apparatus 10 sends the second initial communication signal to the second electronic apparatus 30, and after the time difference, the universal serial bus power-supplying apparatus 10 just sends the first initial communication signal to the first electronic apparatus 20. Therefore, the two electronic apparatuses can simultaneously complete the communications with the universal serial bus power-supplying apparatus 10, and the universal serial bus power-supplying apparatus 10 can simultaneously supply the same voltage to the two electronic apparatuses.

2. If the second communication time is not greater than the first communication time: the first communication time minus the second communication time obtains the time difference by the power delivery communication controller 104. Firstly, the universal serial bus power-supplying apparatus 10 re-powers on the first electronic apparatus 20 and the second electronic apparatus 30, so that the universal serial bus power-supplying apparatus 10 sends the first initial communication signal to the first electronic apparatus 20, and after the time difference, the universal serial bus power-supplying apparatus 10 just sends the second initial communication signal to the second electronic apparatus 30. Therefore, the two electronic apparatuses can simultaneously complete the communications with the universal serial bus power-supplying apparatus 10, and the universal serial bus power-supplying apparatus 10 can simultaneously supply the same voltage to the two electronic apparatuses.

(B) The delay communication project comprises following two conditions:

1. If the second communication time is greater than the first communication time: the second communication time minus the first communication time obtains the time difference by the power delivery communication controller 104. Firstly, the universal serial bus power-supplying apparatus 10 re-powers on the first electronic apparatus 20 and the second electronic apparatus 30, so that the universal serial bus power-supplying apparatus 10 sends the first initial communication signal to the first electronic apparatus 20, and the universal serial bus power-supplying apparatus 10 sends the second initial communication signal to the second electronic apparatus 30 at the same time. Later, during a communication process of the universal serial bus power-supplying apparatus 10 and the first electronic apparatus 20, the universal serial bus power-supplying apparatus 10 deliberately delays the time difference to just response the first electronic apparatus 20. Therefore, the two electronic apparatuses can simultaneously complete the communications with the universal serial bus power-supplying apparatus 10, and the universal serial bus power-supplying apparatus 10 can simultaneously supply the same voltage to the two electronic apparatuses.

2. If the second communication time is not greater than the first communication time: the first communication time minus the second communication time obtains the time difference by the power delivery communication controller 104. Firstly, the universal serial bus power-supplying apparatus 10 re-powers on the first electronic apparatus 20 and the second electronic apparatus 30, so that the universal serial bus power-supplying apparatus 10 sends the first initial communication signal to the first electronic apparatus 20, and the universal serial bus power-supplying apparatus 10 sends the second initial communication signal to the second electronic apparatus 30. Later, during a communication process of the universal serial bus power-supplying apparatus 10 and the second electronic apparatus 30, the universal serial bus power-supplying apparatus 10 deliberately delays the time difference to just response the second electronic apparatus 30. Therefore, the two electronic apparatuses can simultaneously complete the communications with the universal serial bus power-supplying apparatus 10, and the universal serial bus power-supplying apparatus 10 can simultaneously supply the same voltage to the two electronic apparatuses.

In other words, if the magnitude of the requirement voltage of the first electronic apparatus 20 indicated by the first requirement signal is equal to the magnitude of the requirement voltage of the second electronic apparatus 30 indicated by the second requirement signal (for example, the magnitude of the requirement voltage of the first electronic apparatus 20 indicated by the first requirement signal is, for example, 9 volts, which is greater than 5 voles, and which is equal to the magnitude of the requirement voltage of the second electronic apparatus 30 indicated by the second requirement signal), the universal serial bus power-supplying apparatus 10 utilizes the projects mentioned above to simultaneously send a voltage having the magnitude of the requirement voltage of the first electronic apparatus 20 indicated by the first requirement signal to the first electronic apparatus 20 and the second electronic apparatus 30 to drive the first electronic apparatus 20 and the second electronic apparatus 30.

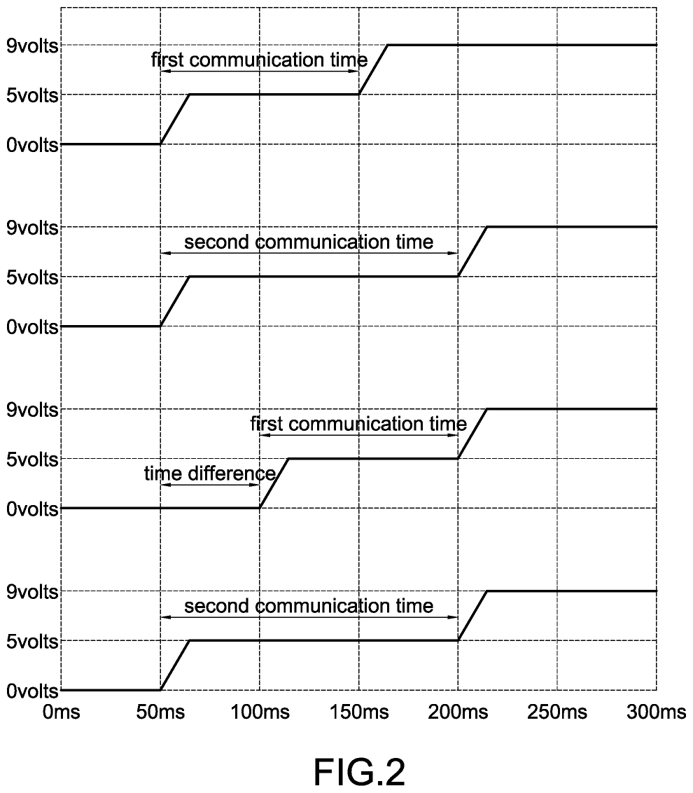

FIG. 2 shows a timing diagram of the delay power-on project of the present invention. FIG. 2 takes the second communication time greater than the first communication time as an example. In FIG. 2, from top to bottom the first waveform indicates that the first electronic apparatus 20 is solely connected to the universal serial bus power-supplying apparatus. As shown in FIG. 2, the first communication time of the first electronic apparatus 20 and the universal serial bus power-supplying apparatus is 100 ms (150 ms−50 ms=100 ms). The requirement voltage of the first electronic apparatus 20 is 9 volts. From top to bottom the second waveform indicates that the second electronic apparatus 30 is solely connected to the universal serial bus power-supplying apparatus. As shown in FIG. 2, the second communication time of the second electronic apparatus 30 and the universal serial bus power-supplying apparatus is 150 ms (200 ms−50 ms=150 ms). The requirement voltage of the second electronic apparatus 30 is 9 volts. From top to bottom the third waveform indicates that the time difference (150 ms−100 ms=50 ms) is obtained from previous communications, so after re-powering on, after the time difference, the universal serial bus power-supplying apparatus 10 just starts to communicate with the first electronic apparatus 20 (namely, just sends the first initial communication signal to the first electronic apparatus 20). From top to bottom the fourth waveform indicates that after re-powering on, the original waveform of the second electronic apparatus 30 is shown. Therefore, the two electronic apparatuses can simultaneously complete the communications with the universal serial bus power-supplying apparatus 10, and the universal serial bus power-supplying apparatus 10 can simultaneously supply the same voltage (for example, 9 volts) to the two electronic apparatuses.

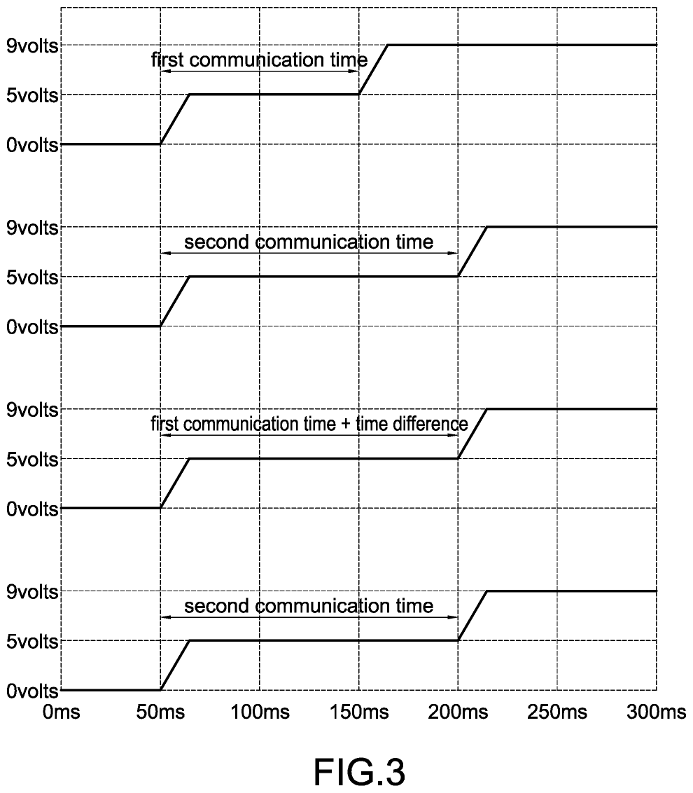

FIG. 3 shows a timing diagram of the delay communication project of the present invention. FIG. 3 takes the second communication time greater than the first communication time as an example. In FIG. 3, the descriptions of the first, second and fourth waveforms from top to bottom are the same with the descriptions of the first, second and fourth waveforms from top to bottom in FIG. 2, and are omitted here for brevity. In FIG. 3, from top to bottom the third waveform indicates that the time difference (150 ms−100 ms=50 ms) is obtained from previous communications, so after re-powering on, during the communication process of the universal serial bus power-supplying apparatus 10 and the first electronic apparatus 20, the universal serial bus power-supplying apparatus 10 deliberately delays the time difference to just response the first electronic apparatus 20. Namely, the original first communication time (100 ms) of the first electronic apparatus 20 plus the time difference (50 ms) is equal to the second communication time (150 ms) of the second electronic apparatus 30. Therefore, the two electronic apparatuses can simultaneously complete the communications with the universal serial bus power-supplying apparatus 10, and the universal serial bus power-supplying apparatus 10 can simultaneously supply the same voltage (for example, 9 volts) to the two electronic apparatuses.

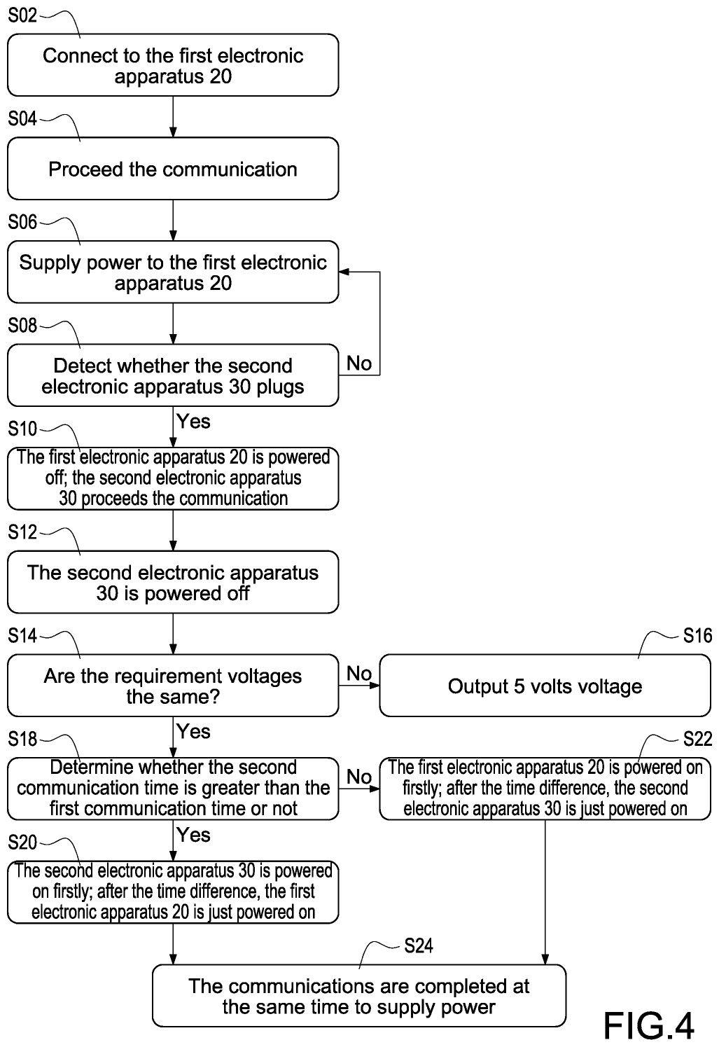

FIG. 4 shows a flow chart of the method applied to the universal serial bus power-supplying apparatus of the present invention (for the delay power-on project); it is also called “a power-supplying method for the universal serial bus power-supplying apparatus with delay functions”. Please refer to FIG. 1 at the same time. The power-supplying method comprises following steps:

Step S02: Connect to the first electronic apparatus 20. Namely, the first electronic apparatus 20 is connected to the universal serial bus power-supplying apparatus 10. Then, the power-supplying method goes to Step S04.

Step S04: Proceed the communication. Namely, the universal serial bus power-supplying apparatus 10 (sending out 5 volts) proceeds the communication with the first electronic apparatus 20, so that the universal serial bus power-supplying apparatus 10 is aware of the first requirement signal and the first communication time. Then, the power-supplying method goes to Step S06.

Step S06: Supply power to the first electronic apparatus 20. Namely, in accordance with the magnitude of the requirement voltage of the first electronic apparatus 20 indicated by the first requirement signal, the universal serial bus power-supplying apparatus 10 supplies power to the first electronic apparatus 20 to drive the first electronic apparatus 20. Then, the power-supplying method goes to Step S08.

Step S08: Detect whether the second electronic apparatus 30 plugs. Namely, the universal serial bus power-supplying apparatus 10 detects whether the second electronic apparatus 30 plugs into the universal serial bus power-supplying apparatus 10 or not. If no (namely, the second electronic apparatus 30 does not plug), the power-supplying method goes back to Step S06. If yes (namely, the second electronic apparatus 30 plugs), the power-supplying method goes to Step S10.

Step S10: The first electronic apparatus 20 is powered off; the second electronic apparatus 30 proceeds the communication. Namely, the universal serial bus power-supplying apparatus 10 stops supplying power to the first electronic apparatus 20, wherein originally the power supplied to the first electronic apparatus 20 is in accordance with the magnitude of the requirement voltage of the first electronic apparatus 20 indicated by the first requirement signal. The universal serial bus power-supplying apparatus 10 (sending out 5 volts) proceeds the communication with the second electronic apparatus 30, so that the universal serial bus power-supplying apparatus 10 is aware of the second requirement signal and the second communication time. Then, the power-supplying method goes to Step S12.

Step S12: The second electronic apparatus 30 is powered off. Namely, the universal serial bus power-supplying apparatus 10 stops communicating with the second electronic apparatus 30. Then, the power-supplying method goes to Step S14.

Step S14: Are the requirement voltages the same? Namely, the universal serial bus power-supplying apparatus 10 is configured to determine whether the magnitude of the requirement voltage of the first electronic apparatus 20 indicated by the first requirement signal is equal to the magnitude of the requirement voltage of the second electronic apparatus 30 indicated by the second requirement signal or not. If they are different, the power-supplying method goes to Step S16. If they are the same, the power-supplying method goes to Step S18.

Step S16: Output 5 volts voltage. Namely, the universal serial bus power-supplying apparatus 10 will communicate with the first electronic apparatus 20 and the second electronic apparatus 30 again after re-powering on, and after the communications have been completed, the universal serial bus power-supplying apparatus 10 will output only 5 volts voltage.

Step S18: Determine whether the second communication time is greater than the first communication time or not. If yes, the power-supplying method goes to Step S20; at this time the present invention also obtains the time difference from the second communication time minus the first communication time. If no, the power-supplying method goes to Step S22; at this time the present invention also obtains the time difference from the first communication time minus the second communication time.

Step S20: The second electronic apparatus 30 is powered on firstly; after the time difference, the first electronic apparatus 20 is just powered on. Then, the power-supplying method goes to Step S24. Namely, firstly the universal serial bus power-supplying apparatus 10 sends the second initial communication signal to the second electronic apparatus 30, and after the time difference, the universal serial bus power-supplying apparatus 10 just sends the first initial communication signal to the first electronic apparatus 20.

Step S22: The first electronic apparatus 20 is powered on firstly; after the time difference, the second electronic apparatus 30 is just powered on. Then, the power-supplying method goes to Step S24. Namely, firstly the universal serial bus power-supplying apparatus 10 sends the first initial communication signal to the first electronic apparatus 20, and after the time difference, the universal serial bus power-supplying apparatus 10 just sends the second initial communication signal to the second electronic apparatus 30.

Step S24: The communications are completed at the same time to supply power. Namely, the two electronic apparatuses can simultaneously complete the communications with the universal serial bus power-supplying apparatus 10; the universal serial bus power-supplying apparatus 10 can simultaneously supply the same voltage to the two electronic apparatuses (namely, the voltage having the magnitude of the requirement voltage of the first electronic apparatus 20 indicated by the first requirement signal, which is also equal to the voltage having the magnitude of the requirement voltage of the second electronic apparatus 30 indicated by the second requirement signal).

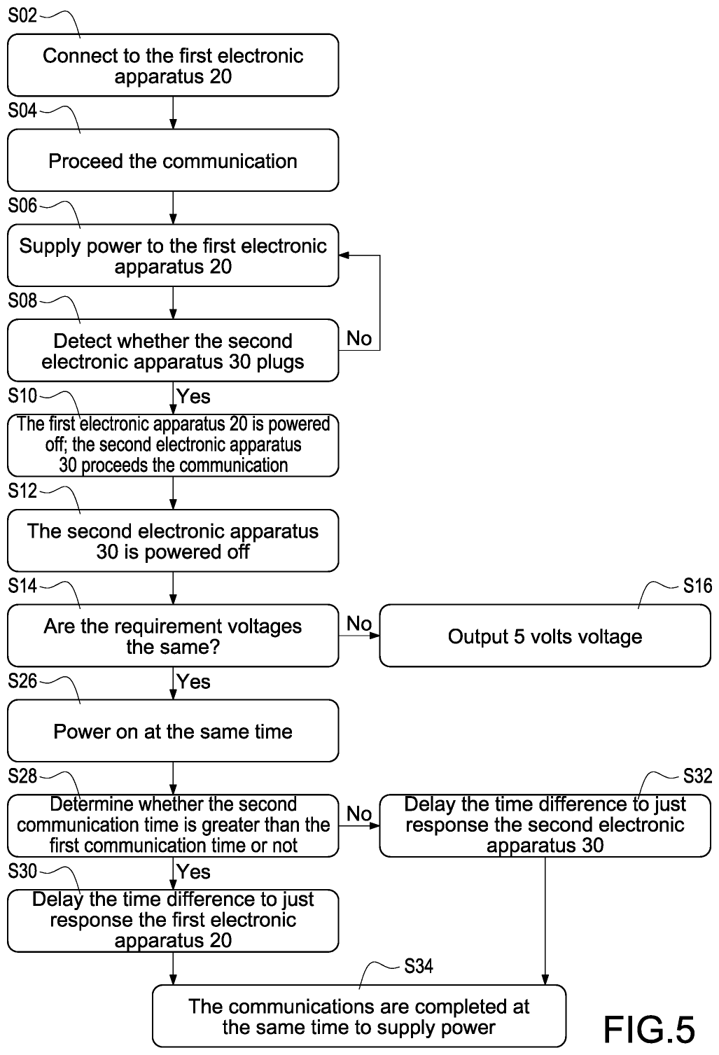

FIG. 5 shows a flow chart of the method applied to the universal serial bus power-supplying apparatus of the present invention (for the delay communication project). The contents of FIG. 5 which are the same with the contents of FIG. 4 are not repeated here for brevity. Moreover, after Step S14, if the two requirement voltages of the two electronic apparatuses are the same, the power-supplying method goes to Step S26.

Step S26: Power on at the same time. Then, the power-supplying method goes to Step S28. Namely, the universal serial bus power-supplying apparatus 10 sends the first initial communication signal to the first electronic apparatus 20, and the universal serial bus power-supplying apparatus 10 sends the second initial communication signal to the second electronic apparatus 30 at the same time.

Step S28: Determine whether the second communication time is greater than the first communication time or not. If yes, the power-supplying method goes to Step S30; at this time the present invention also obtains the time difference from the second communication time minus the first communication time. If no, the power-supplying method goes to Step S32; at this time the present invention also obtains the time difference from the first communication time minus the second communication time.

Step S30: Delay the time difference to just response the first electronic apparatus 20. Then, the power-supplying method goes to Step S34. Namely, during the communication process of the universal serial bus power-supplying apparatus 10 and the first electronic apparatus 20, the universal serial bus power-supplying apparatus 10 deliberately delays the time difference to just response the first electronic apparatus 20.

Step S32: Delay the time difference to just response the second electronic apparatus 30. Then, the power-supplying method goes to Step S34. Namely, during the communication process of the universal serial bus power-supplying apparatus 10 and the second electronic apparatus 30, the universal serial bus power-supplying apparatus 10 deliberately delays the time difference to just response the second electronic apparatus 30.

Step S34: The communications are completed at the same time to supply power. Namely, the two electronic apparatuses can simultaneously complete the communications with the universal serial bus power-supplying apparatus 10; the universal serial bus power-supplying apparatus 10 can simultaneously supply the same voltage to the two electronic apparatuses (namely, the voltage having the magnitude of the requirement voltage of the first electronic apparatus 20 indicated by the first requirement signal, which is also equal to the voltage having the magnitude of the requirement voltage of the second electronic apparatus 30 indicated by the second requirement signal).

The advantage of the present invention is that the universal serial bus power-supplying apparatus can simultaneously supply the voltage more than 5 volts to more than two electronic apparatuses but only one power convertor is requested and utilized. Moreover, in an embodiment of the present invention, “determine whether the magnitude of the requirement voltage of the first electronic apparatus 20 indicated by the first requirement signal is equal to the magnitude of the requirement voltage of the second electronic apparatus 30 indicated by the second requirement signal” mentioned above means that: Determine a maximum same value in the kinds of the requirement voltage of the first electronic apparatus 20 and the kinds of the requirement voltage of the second electronic apparatus 30. “If they are different” mentioned above means that: the maximum same value in the kinds of the requirement voltage of the first electronic apparatus 20 and the kinds of the requirement voltage of the second electronic apparatus 30 is only 5 volts. “If they are the same” mentioned above means that: the maximum same value in the kinds of the requirement voltage of the first electronic apparatus 20 and the kinds of the requirement voltage of the second electronic apparatus 30 is greater than 5 volts (for example, 9 volts). For example, the requirement voltage of the first electronic apparatus 20 comprises only 5 volts; the requirement voltage of the second electronic apparatus 30 comprises 5 volts and 9 volts; the maximum same value in the kinds of the requirement voltage of the first electronic apparatus 20 and the kinds of the requirement voltage of the second electronic apparatus 30 is only 5 volts, so that this condition is referred as “If they are different” mentioned above. For another example, the requirement voltage of the first electronic apparatus 20 comprises 5 volts, 9 volts and 12 volts; the requirement voltage of the second electronic apparatus 30 comprises 5 volts and 9 volts; the maximum same value in the kinds of the requirement voltage of the first electronic apparatus 20 and the kinds of the requirement voltage of the second electronic apparatus 30 is 9 volts (greater than 5 volts), so that this condition is referred as “If they are the same” mentioned above.

What is claimed is:

1. A universal serial bus power-supplying apparatus with delay functions, the universal serial bus power-supplying apparatus applied to a first electronic apparatus and a second electronic apparatus, the universal serial bus power-supplying apparatus comprising:
a power convertor;
a power delivery communication controller electrically connected to the power convertor; and
a plurality of switch units electrically connected to the power convertor and the power delivery communication controller,
wherein the power delivery communication controller is configured to calculate a first communication time between the universal serial bus power-supplying apparatus and the first electronic apparatus; the power delivery communication controller is configured to calculate a second communication time between the universal serial bus power-supplying apparatus and the second electronic apparatus; the universal serial bus power-supplying apparatus is configured to utilize a time difference between the first communication time and the second communication time to simultaneously supply power to the first electronic apparatus and the second electronic apparatus to drive the first electronic apparatus and the second electronic apparatus.

2. The universal serial bus power-supplying apparatus in claim 1, wherein the first communication time is defined as: from the universal serial bus power-supplying apparatus sends out a first initial communication signal, until the universal serial bus power-supplying apparatus receives a first requirement signal;
wherein the first initial communication signal sent by the universal serial bus power-supplying apparatus is sent to the first electronic apparatus; the first requirement signal received by the universal serial bus power-supplying apparatus is sent by the first electronic apparatus; the first requirement signal is used to indicate a magnitude of a requirement voltage of the first electronic apparatus.

3. The universal serial bus power-supplying apparatus in claim 2, wherein the second communication time is defined as: from the universal serial bus power-supplying apparatus sends out a second initial communication signal, until the universal serial bus power-supplying apparatus receives a second requirement signal;
wherein the second initial communication signal sent by the universal serial bus power-supplying apparatus is sent to the second electronic apparatus; the second requirement signal received by the universal serial bus power-supplying apparatus is sent by the second electronic apparatus; the second requirement signal is used to indicate a magnitude of a requirement voltage of the second electronic apparatus.

4. The universal serial bus power-supplying apparatus in claim 3, wherein the magnitude of the requirement voltage of the first electronic apparatus indicated by the first requirement signal is equal to the magnitude of the requirement voltage of the second electronic apparatus indicated by the second requirement signal; the magnitude of the requirement voltage of the first electronic apparatus indicated by the first requirement signal is greater than 5 volts; the universal serial bus power-supplying apparatus is configured to simultaneously send a voltage having the magnitude of the requirement voltage of the first electronic apparatus indicated by the first requirement signal to the first electronic apparatus and the second electronic apparatus to drive the first electronic apparatus and the second electronic apparatus.

5. The universal serial bus power-supplying apparatus in claim 4, wherein when the first electronic apparatus is connected to the universal serial bus power-supplying apparatus and the universal serial bus power-supplying apparatus supplies power to the first electronic apparatus to drive the first electronic apparatus: if the second electronic apparatus intends to connect to the universal serial bus power-supplying apparatus and after the second electronic apparatus is connected to the universal serial bus power-supplying apparatus, the universal serial bus power-supplying apparatus is configured to stop supplying power to the first electronic apparatus, so that the power delivery communication controller is configured to calculate the second communication time between the universal serial bus power-supplying apparatus and the second electronic apparatus, and later the universal serial bus power-supplying apparatus is configured to stop communicating with the second electronic apparatus.

6. The universal serial bus power-supplying apparatus in claim 5, wherein if the second communication time is greater than the first communication time: the second communication time minus the first communication time obtains the time difference by the power delivery communication controller; firstly, the universal serial bus power-supplying apparatus is configured to send the second initial communication signal to the second electronic apparatus, and after the time difference, the universal serial bus power-supplying apparatus is configured to just send the first initial communication signal to the first electronic apparatus.

7. The universal serial bus power-supplying apparatus in claim 5, wherein if the second communication time is not greater than the first communication time: the first communication time minus the second communication time obtains the time difference by the power delivery communication controller; firstly, the universal serial bus power-supplying apparatus is configured to send the first initial communication signal to the first electronic apparatus, and after the time difference, the universal serial bus power-supplying apparatus is configured to just send the second initial communication signal to the second electronic apparatus.

8. The universal serial bus power-supplying apparatus in claim 5, wherein if the second communication time is greater than the first communication time: the second communication time minus the first communication time obtains the time difference by the power delivery communication controller; the universal serial bus power-supplying apparatus is configured to send the first initial communication signal to the first electronic apparatus, and the universal serial bus power-supplying apparatus is configured to simultaneously send the second initial communication signal to the second electronic apparatus; later, during a communication process of the universal serial bus power-supplying apparatus and the first electronic apparatus, the universal serial bus power-supplying apparatus is configured to delay the time difference to just response the first electronic apparatus.

9. The universal serial bus power-supplying apparatus in claim 5, wherein if the second communication time is not greater than the first communication time: the first communication time minus the second communication time obtains the time difference by the power delivery communication controller; the universal serial bus power-supplying apparatus is configured to send the first initial communication signal to the first electronic apparatus, and the universal serial bus power-supplying apparatus is configured to simultaneously send the second initial communication signal to the second electronic apparatus; later, during a communication process of the universal serial bus power-supplying apparatus and the second electronic apparatus, the universal serial bus power-supplying apparatus is configured to delay the time difference to just response the second electronic apparatus.

10. The universal serial bus power-supplying apparatus in claim 1, further comprising:
a memory unit electrically connected to the power delivery communication controller,
wherein the memory unit is configured to store the first communication time, the second communication time and the time difference; the time difference is greater than 0 second.
